(19) United States
(12) Patent Application Publication
(10) Pub. No.: US 2010/0191480 A1
(43) Pub. Date: Jul. 29, 2010

(54) TORQUE TRANSFER MEASUREMENT SYSTEM

(75) Inventor: Richard J. Wise, Kelowna (CA)

Correspondence Address: PRASS LLP, 2661 Riva Road, Bldg. 1000, Suite 1044, ANNAPOLIS, MD, 21401, US

(73) Assignee: Magnetic Torque International, Ltd., Reston, VA (US)

(21) Appl. No.: 12/522,622

(22) PCT Filed: Jan. 8, 2008
(86) PCT No.: PCT/US08/00280

§ 371 Date: Mar. 22, 2010

Related U.S. Application Data
(60) Provisional application No. 60/879,331, filed on Jan. 9, 2007.

(51) Int. Cl. G06F 19/00; G01P 3/00; G01L 3/00

(52) U.S. Cl. 702/41; 702/145; 702/182

(57) ABSTRACT

A measurement system is provided for measuring parameters of a motion system. The measurement system includes a sensor for sensing the passing of a magnetic field as the source of the magnetic field passes the sensor; a processor for processing a signal generated by the sensor; a calculator for calculating various performance parameters of the motion system; and an output portion for sending the various parameters to a down stream system.

### BACKGROUND OF THE INVENTION

1. Field of the Invention

The invention relates to measurement systems and more particularly to a torque transfer measurement system.

2. Discussion of the Related Art

In general, transmission of rotational motion is accomplished by coupling rotating shafts using a combination of physically connected members. For example, in order to transfer rotational motion from a first rotational shaft to a second rotational shaft, either gears, belts, or chains are commonly used. However, due to mechanical friction between the physically connected members, significant amounts of heat are generated that causes premature failures of the physically connected members and increases costs and loss of productivity due to repairs. Moreover, although the mechanical friction may be reduced by supplying a lubricant to the physically connected members, operational speed of the physically connected members has a maximum upper limit, thereby severely limiting transfer of the rotational motion between the first and second rotational shafts.

In addition, safety devices are commonly implemented to prevent damage to the first and second rotation shafts, as well as to the physically connected members. For example, shear devices are commonly used that mechanically disconnect either the rotating shafts or physically connected members in the event that a maximum torque limit is achieved. Thus, in the event that the maximum torque limit is achieved, the shear device must be replaced, thereby increasing costs and decreasing productivity.

Furthermore, alignment of the first and second rotational shafts must be maintained at all times in order to prevent any shearing stresses on the rotational shafts. Moreover, any misalignment of the first and second rotational shafts will result in a transfer of corresponding shearing stresses to the physically connected members.

In addition, monitoring and measurement of the performance of the first and second rotational shafts must be provided without interference. Specifically, a system to monitor and measure the performance of the first and second rotational shafts should include non-contacting means.

### SUMMARY OF THE INVENTION

Particular embodiments of the invention provide a measurement system for measuring parameters of a motion system. The measurement system includes a sensor for sensing the passing of a magnetic field as the source of the magnetic field passes the sensor; a processor for processing a signal generated by the sensor; a calculator for calculating various performance parameters of the motion system; and an output portion for sending the various parameters to a down stream system.

Particular embodiments of the invention provide a method of measuring parameters of a motion system. The method includes sensing the passing of a magnetic field as the source of the magnetic field passes a sensor; processing a signal generated by the sensor; calculating various performance parameters of the motion system; and sending the various parameters to a down stream system.

Additional features and advantages of the invention will be set forth in the description which follows, and in part will be apparent from the description, or may be learned by practice of the invention. Objectives and other advantages of the invention will be realized and attained by the structure particularly pointed out in the written description as well as the appended drawings.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective schematic view of a torque transfer system;

FIG. 2 is a side schematic view of a measurement system in accordance with an embodiment of the invention;

FIG. 3 is a side schematic view of another measurement system in accordance with an embodiment of the invention;

FIG. 4 is a side schematic view of another measurement system in accordance with an embodiment of the invention; and

FIG. 5 is a side schematic view of another measurement system in accordance with an embodiment of the invention.

### DETAILED DESCRIPTION OF EMBODIMENTS OF THE INVENTION

Reference will now be made in detail to embodiments of the invention, examples of which are illustrated in the accompanying drawings.

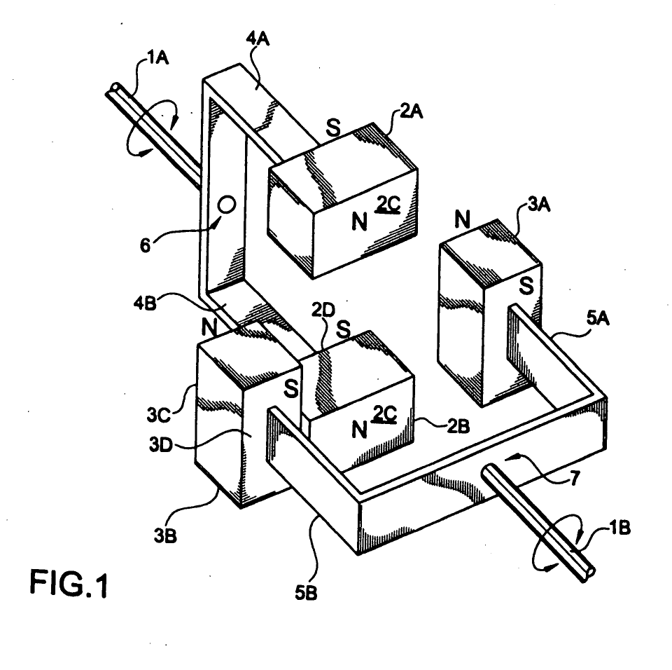

FIG. 1 is a perspective view of an exemplary torque transfer system according to the invention. In FIG. 1, a torque transfer system may include a first rotational shaft 1A and a second rotational shaft 1B. Both the first and second rotational shafts 1A and 1B may be coupled to other devices that may make use of the rotational motion and torque transmitted by the first and second rotational shafts 1A and 1B. In addition, the first rotational shaft 1A may be coupled to a first pair of magnetic members 2A and 2B via first coupling arms 4A and 4B, respectively, using a shaft coupling 6. Similarly, the second rotational shaft 1B may be coupled to a second pair of magnetic members 3A and 3B via second coupling arms 5A and 5B, respectively, using a shaft coupling 7. Accordingly, the first pair of magnetic members 2A and 2B may be aligned with each other along a first direction, and the second pair of magnetic members 3A and 3B may be aligned with each other along a second direction perpendicular to the first direction. The first and second coupling arms 4A/4B and 5A/5B may be made of non-magnetic material(s), thereby preventing any adverse reaction with the first and second magnetic members 2A/2B and 3A/3B. Of course, if the first and second rotational shafts 1A and 1B are made of non-magnetic material(s), then the first and second coupling arms 4A/4B and 5A/5B may not be necessary. Thus, the first and second magnetic members 2A/2B and 3A/3B may be configured to be coupled to the first and second rotational shafts 1A and 1B using a rotational disks, thereby providing improved rotational stabilization and improved precision.

In FIG. 1, the first pair of magnetic members 2A and 2B may have a polar orientation such that first faces 2C of the first pair of magnetic members 2A and 2B are magnetic North poles facing toward the second pair of magnetic members 3A and 3B, and second faces 2D of the first pair of magnetic members 2A and 2B face toward the first rotational shaft 1A. In addition, the second pair of magnetic members 3A and 3B may have a polar orientation such that first faces 3C of the second pair of magnetic members 3A and 3B North poles face toward the first pair of magnetic members 2A and 2B, and second faces 3D of the second pair of magnetic members 3A and 3B that face toward the second rotational shaft 1A. Accordingly, the opposing first faces 2C and 3C of the first and second magnetic members 2A/2B and 3A/3B, respectively, may have like polar orientation. Although FIG. 1 shows that the opposing first faces 2C and 3C of the first and second magnetic members 2A/2B and 3A/3B, respectively, may have North magnetic polar orientations, the opposing first faces 2C and 3C of the first and second magnetic members 2A/2B and 3A/3B, respectively, may have South magnetic polar orientations.

Accordingly, as the first rotational shaft 1A rotates about a first axial direction, the second magnetic members 3A and 3B are repelled by the first magnetic members 2A and 2B, thereby rotating the second rotational shaft 1B about a second axial direction identical to the first axial direction. Conversely, as rotation of the first rotational shaft 1A is reduced or increased along the first axial direction, rotation of the second rotational shaft 1B is reduced or increased by a direct correlation. Thus, as rotational torque increases or decreases along the first rotational shaft 1A, a corresponding amount of rotational torque may increase or decrease along the second rotational shaft 1B.

However, if the amount of torque transmitted along the first rotational shaft 1A abruptly stops or abruptly increases, the magnetic repulsion between the first and second magnetic members 2A/2B and 3A/3B may be overcome. Accordingly, the first rotational shaft 1A may actually rotate at least one-half of a revolution with respect to rotation of the second rotational shaft 1B. Thus, the abrupt stoppage or increase of the torque transmitted along the first rotational shaft 1A may be accommodated by the first and second magnetic members 2A/2B and 3A/3B, thereby preventing any damage to the second rotational shaft 1B. In other words, if the change of transmitted torque exceeds the magnetic repulsion of the first and second magnetic members 2A/2B and 3A/3B, then the second rotational shaft 1B may “slip” in order to accommodate the change in torque. As compared to the related art, no shearing device may be necessary in order to prevent damage to the second rotational shaft 1B by the abrupt stoppage or increase of the torque transmitted along the first rotational shaft 1A.

In addition, since no additional mechanical members are necessary to transmit the rotational motion, as well as rotational torque, from the first rotational shaft 1A to the second rotational shaft 1B, heat is not generated nor is any noise generated. Thus, according to the invention, no heat signature is created nor is any traceable noise generated. Thus, the invention is applicable to systems that require stealth operation.

According to the invention, various types and configurations of magnetic members may be implemented to achieve the same transfer of rotational torque from one shaft to another shaft. For example, the geometric shape and size of the first and second magnetic members 2A/2B and 3A/3B may be changed in order to provide specific magnetic coupling of the first and second rotational shafts 1A and 1B. Thus, the geometric shape and size of the first and second magnetic members 2A/2B and 3A/3B may include curved magnets, circular magnets, or non-linear geometries. Moreover, each of the first magnetic members 2A and 2B may have a first geometry and size and each of the second magnetic members 3A and 3B may have a second geometry and size different from the first geometry and size.

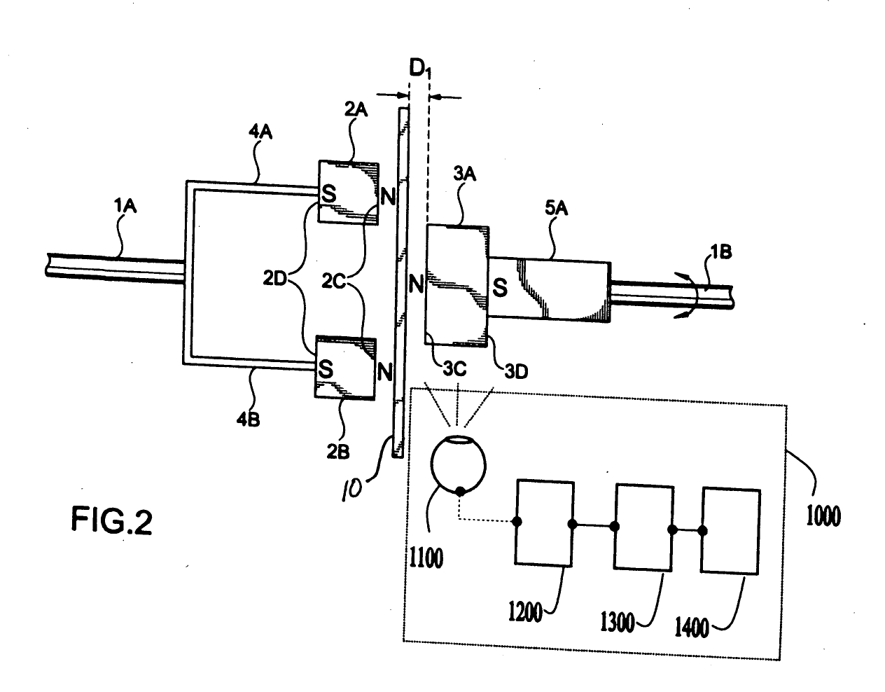

FIG. 2 is a side view of another exemplary torque transfer system according to the present invention. In FIG. 2, each of the first and second magnetic members 2A/2B and 3A/3B may be disposed on either side of a barrier 10. Accordingly, the barrier 10 may be made from non-magnetic material(s), thereby preventing interference with the magnetic fields of the first and second magnetic members 2A/2B and 3A/3B. Moreover, each of the first and second magnetic members 2A/2B and 3A/3B may be spaced apart from the barrier 10 by a distance D1 along opposing side surfaces of the barrier 10. Accordingly, the distance D1 may be adjusted to provide specific magnetic field coupling strengths between the first and second magnetic members 2A/2B and 3A/3B. In addition, a thickness of the barrier may be adjusted to also provide specific magnetic field coupling strength between the first and second magnetic members 2A/2B and 3A/3B. Furthermore, the barrier 10 may comprise a composite of different materials that may provide specific magnetic field coupling strength between the first and second magnetic members 2A/2B and 3A/3B. In either event, the spacing D1 and/or the barrier 10, and barrier material(s), may be selected to provide specific magnetic field coupling strength between the first and second magnetic members 2A/2B and 3A/3B.

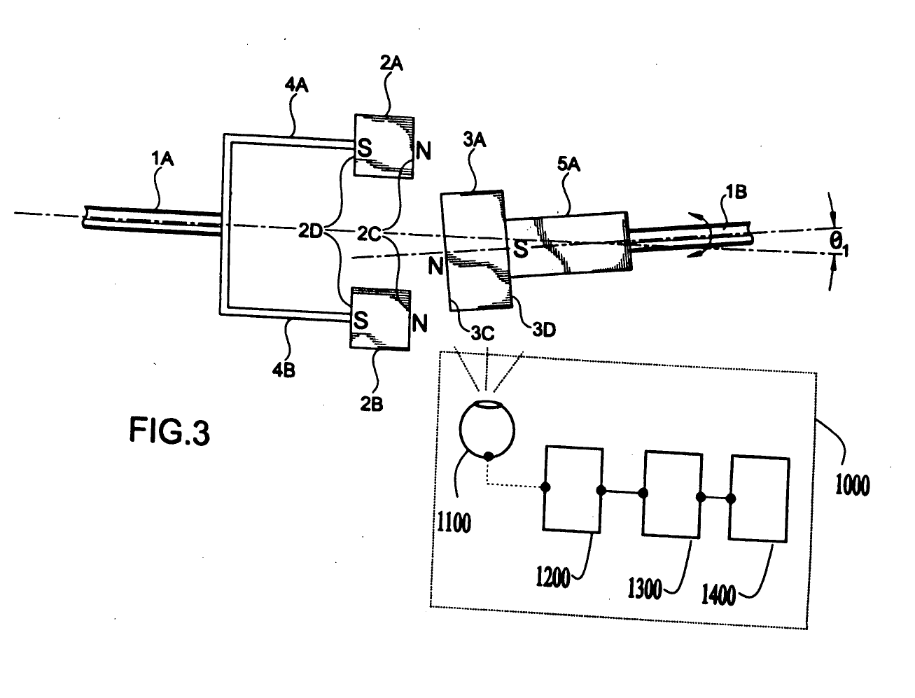

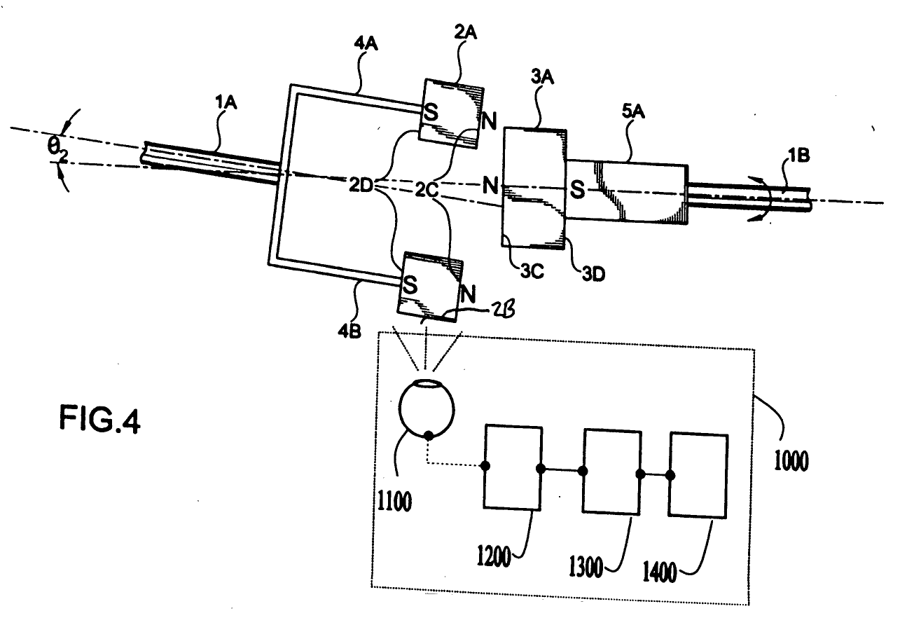

FIG. 3 is a side view of another exemplary torque transfer system according to the invention. In FIG. 3, the first and second rotational shafts 1A and 1B may be offset from one another by an angle θ₁, wherein the first rotational shaft 1A extends along a first axial direction and the second rotational shaft 1B extends along a second axial direction that differs from the first axial direction by the angle θ₁. Accordingly, the first faces 3C of the second pair of magnetic members 3A and 3B may be skewed (i.e., antiparallel) from the first faces 2C of the first pair of magnetic members 2A and 2B. Thus, the offset of the first and second rotational shafts 1A and 1B may be accommodated by an adjustment of the repelling magnetic fields between the first and second pairs of magnetic members 2A/2B and 3A/3B. Moreover, as shown in FIG. 4, the first and second rotational shafts 1A and 1B may be offset from one another by an angle θ₂, wherein the first rotational shaft 1A extends along a first axial direction and the second rotational shaft 1B extends along a second axial direction that differs from the first axial direction by the angle θ₂.

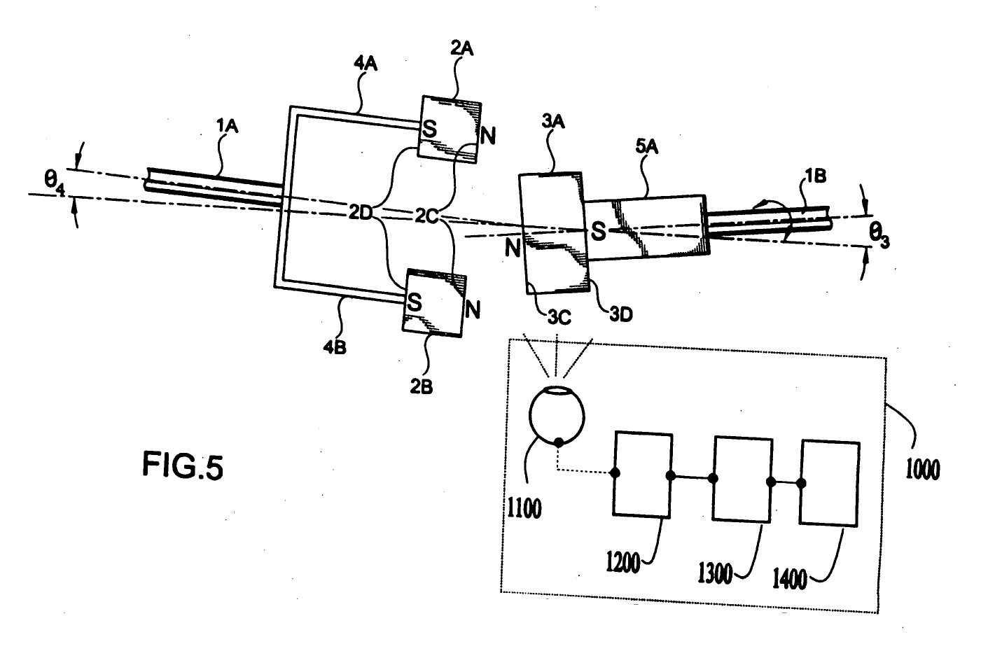

Furthermore, as shown in FIG. 5, the first and second rotational shafts 1A and 1B may be mutually offset from a center line angles of θ₃ and θ₄, wherein the first rotational shaft 1A extends along a first axial direction offset from a center line by the angle θ₄ and the second rotational shaft 1B extends along a second axial direction offset from the center line by the angle θ₃ that may, or may not differ from the angle θ₄.

In FIGS. 3, 4, and 5, the angles θ₁, θ₂, θ₃, and θ₄ may all be the same or may be different from each other. For example, angles θ₁, θ₂, θ₃, and θ₄ may be within a range from slightly more than 0 degrees to slightly less than 45 degrees. Accordingly, the magnetic strengths of the first and second pairs of magnetic members 2A/2B and 3A/3B, as well as the distances separating the first and second pairs of magnetic members 2A/2B and 3A/3B, may determine the ranges for the angles θ₁, θ₂, θ₃, and θ₄. Furthermore, the distances between the first faces 3C of the second pair of magnetic members 3A and 3B and the first faces 2C of the first pair of magnetic members 2A and 2B may determine the ranges for the angles θ₁, θ₂, θ₃, and θ₄.

Although not shown in FIGS. 3, 4, and 5, a barrier (similar to the barrier 10, in FIG. 2), may be disposed between the first and second pairs of magnetic members 2A/2B and 3A/3B. In addition, the barrier (not shown) may not necessarily be a flat-type barrier, but may have a plurality of different geometries. For example, the barrier (not shown) may be formed of a curved surface or a non-linear surface.

In FIGS. 2-5, performance parameters of a torque transfer system may be monitored using a monitoring system 1000. The monitoring system 1000 may include a sensor portion 1100, a signal conditioner and processor portion 1200, a calculator portion 1300, and an output portion 1400. The sensor portion 1100 may include a Hall Effect sensor or a solenoid pick-up to sense the magnets 2/3 as they pass by during rotation of the first and second rotational shafts 1A and 1B. Accordingly, the frequency of the passing magnets 2/3 may be measured by a plurality of pulse signals, as well as the time between the passing magnets 2/3 may be measured by a plurality of pulse signals. Next, the pulse signals may be processed by the signal conditioner and processor portion 1200. Then, the processed pulse signals may be output to the calculator portion 1300 to continually calculate various performance parameters, such as torque and speed directly and horsepower via calculation, of the torque transfer system.

In FIGS. 2-5, the calculator portion 1300 may use the processed pulse signals to calculate torque being transmitted between the first and second rotational shafts 1A and 1B. In addition, the processed pulse signals may be used to calculate revolutions per minute of the torque transfer system 1100, as well as to calculate horsepower. Finally, the calculated performance parameters may be output via the output portion 1400. The output performance parameters may be remotely sent to a control center to monitor the performance parameters of the torque transfer system, or may be displayed directly adjacent to the torque transfer system. Any significant changes in any of the torque, RPM, and/or horsepower may be indicative of problems associated with the torque transfer system, or problems associated with the load and/or drive source connected to the torque transfer system. Moreover, the performance parameters of the torque transfer system may be used as feedback for automated direct control of the load and/or drive source.

In FIGS. 2-5, the monitoring system 1000 may monitor either magnets 2 or 3. Alternatively, a dual monitoring system may include a first sensor portion to monitor magnets 2 of the first rotational shaft 1A and a second sensor portion to monitor magnets 3 of the second rotational shaft 1B. Accordingly, the dual monitoring system may include a single signal conditioner, and single processor portion, a single calculator portion, and either plural output portions or one single output portion.

According to the invention, the signal conditioner and processor portion 1200, calculator portion 1300, and output portion 1400 may be implemented by a programmed computer.

It will be apparent to those skilled in the art that various modifications and variations can be made to the examples of the invention described without departing from the spirit or scope of the invention.

I claim:

1. A measurement system for measuring parameters of a motion system, comprising:
a sensor for sensing the passing of a magnetic field as the source of the magnetic field passes the sensor;
a processor for processing a signal generated by the sensor;
a calculator for calculating various performance parameters of the motion system; and
an output portion for sending the various parameters to a down stream system.

2. The system of claim 1, wherein the sensor is a Hall Effect sensor.

3. The system of claim 1, wherein the sensor is a solenoid pick-up.

4. The system of claim 1, wherein the calculator is for calculating rotational speed of the motion system.

5. The system of claim 1, wherein the calculator is for calculating torque and/or power.

6. A motion system comprising:
a magnetic field generating portion that moves;
the system of claim 1 that senses the movement of the magnetic field generating portion.

7. The system of claim 6, wherein the sensor is a Hall Effect sensor.

8. The system of claim 6, wherein the sensor is a solenoid pick-up.

9. The system of claim 6, wherein the calculator is for calculating rotational speed of the motion system.

10. The system of claim 6, wherein the calculator is for calculating torque and/or power.

11. A method of measuring parameters of a motion system, the method comprising:
sensing the passing of a magnetic field as the source of the magnetic field passes a sensor;
processing a signal generated by the sensor;
calculating various performance parameters of the motion system; and
sending the various parameters to a down stream system.

12. The method of claim 11, wherein the sensor is a Hall Effect sensor.

13. The method of claim 11, wherein the sensor is a solenoid pick-up.

14. The method of claim 11, wherein the performance parameters include rotational speed of the motion system.

15. The method of claim 11, wherein the performance parameters include torque and/or power.
